(19) United States
(12) Patent Application Publication
(10) Pub. No.: US 2016/0229235 A1
(43) Pub. Date: Aug. 11, 2016

(54) METHOD AND SYSTEM FOR MONITORING A TYRE

(71) Applicant: RENAULT S.A.S., Boulogne Billancourt (FR)

(72) Inventors: Philippe SAINT-LOUP, Jouards-Pontchartrain (FR); Alessandro MONTI, La Garenne-Colombes (FR); Bernard GUILLEREY, Montigny Le Bretonneux (FR)

(73) Assignee: RENAULT s.a.s., Boulogne Billancourt (FR)

(21) Appl. No.: 15/023,198

(22) PCT Filed: Sep. 12, 2014
(86) PCT No.: PCT/FR2014/052270

§ 371 Date: Mar. 18, 2016

(30) Foreign Application Priority Data
Sep. 27, 2013 (FR) 1359353

(51) Int. Cl. B60C 23/04; G08B 21/18

(52) U.S. Cl. CPC B60C 23/0474; B60C 23/0486; G08B 21/182

(57) ABSTRACT

A method for monitoring a tire of a motor vehicle, implemented in a wheel and including: measuring a temperature of the tire, measuring a pressure of the tire, calculating a variation, in absolute value, of the ratio between the measured pressure and the measured temperature, comparing the calculated variation to a predetermined threshold, and sending an alert message to a computer of the vehicle if the calculated variation is above the predetermined threshold.

The present invention relates generally to the field of motor vehicles, and more specifically to a method for monitoring a vehicle tire.

In effect, European regulations will soon be forcing motor vehicle constructors to provide their vehicles with means for monitoring the pressure of the wheels of these vehicles.

Currently, some vehicles are equipped with sensors making it possible to measure the pressure of the tires of these vehicles. Such a sensor is generally situated in the valve of a tire and sends periodically, via a wireless link to a computer of the corresponding vehicle, various information items. These information items notably comprise:
the pressure of the tire,
the temperature of the tire,
a sensor identifier,
information on the level of charge of a battery powering the sensor,
information on movement of the wheel comprising the tire,
a direction of rotation of this wheel,
and an information item making it possible to detect a failure of the sensor.

These information items are processed by a computer of the vehicle, which deduces therefrom the underinflated or otherwise state of the tires of the vehicle. This underinflation information results from an estimation relying on a model using the temperature, the pressure of the tire, and sometimes other information available in the computer of the vehicle.

Thus, the document WO 2007012771 describes a system for estimating the inflation pressure of the tires of a vehicle, tallying the pressure information emitted by these tires with the vertical acceleration values of the wheels of the vehicle.

The patent application FR2998514 describes a system for monitoring the pressure of the tires of a motor vehicle using a pressure sensor situated in each tire of the vehicle, in which there is determined, for each tire, a normal state or a punctured state, or an underinflated state or even a state of pressurization unsuited to high speeds, as a function of the comparison of the pressure of each tire with pressure thresholds relating to each of these states.

However, these existing methods, using pressure and temperature measurements reported periodically by sensors situated in these tires, are slow to determine whether one of these tires is underinflated or not. Notably because of the measurement noises, which are sometimes linked to errors of transmission of the information items received by the computer of the vehicle, the confirmation that a tire is actually underinflated sometimes requires a digital filtering, and/or the crossing by a counter of a high threshold of a number of estimations of low pressure.

These methods are not therefore effective in rapidly detecting a blow-out in particular.

One of the aims of the invention is to remedy at least some of the drawbacks of the prior art by providing a method for monitoring a tire of a motor vehicle and a system for monitoring a tire of a motor vehicle which make it possible to rapidly report to a computer of the vehicle a rapid leak or blow-out problem.

To this end, the invention proposes a method for monitoring a tire of a motor vehicle, implemented in the wheel comprising said tire, said method comprising:
a step of measuring a temperature in said tire,
a step of measuring a pressure in said tire, characterized in that it further comprises:
a step of calculating a variation, as an absolute value, of the ratio between said measured pressure and said measured temperature, over a time period less than a predetermined duration,
a step of comparing said calculated variation to a predetermined threshold,
and a step of sending an alert message to a computer of said vehicle if said calculated variation is above said predetermined threshold over said time period.

By virtue of the invention, the computer of the vehicle rapidly has an information item on the variation of mass of air in the tire of the vehicle, the ratio between the pressure and the temperature of the tire being indicative of the mass of air contained in the tire. This information item directly supplied by the system according to the invention, contained in the wheel, makes it possible to dispense with the climatic pressure variations that cannot easily be filtered in the existing methods for monitoring tires, for example when the vehicle stops after a period of running that has greatly increased the temperature of its tires. The invention therefore makes it possible to avoid the unjustified alerts while rapidly providing an alert of tire blow-out or rapid leak type, in a manner that is robust to the errors due to the transmission of the messages sent by the system according to the invention.

It should be noted that, contrary to the existing methods in which a sensor periodically sends measurements to the computer of the vehicle, for example every second, the invention makes it possible to warn the computer of a problem much more rapidly, for example in a few tens of milliseconds, while dispensing with this periodicity.

Furthermore, the invention makes it possible to save on the battery powering the sensor when it is used instead of this periodic sending of measurements to the computer, although it can also be used in addition to the existing methods.

According to an advantageous feature of the invention, said alert message comprises the sign of said calculated variation. Thus, the invention makes it possible to distinguish a pressure leak from a reinflation of the tire.

According to another advantageous feature of the invention, said alert message comprises the absolute value of said calculated variation, as well as the value of said time period.

These additional information items make it possible for the computer of the vehicle to distinguish a slow blow-out from a rapid tire pressure leak.

According to another advantageous feature of the invention, said alert message comprises measurement values of said measured pressure and of said measured temperature over said time period.

These additional information items make it possible for the computer to check the consistency of the data supplied by the system according to the invention and deduce therefrom any possible failure thereof.

According to another advantageous feature of the invention, said alert message is encrypted. This additional feature also makes it possible to improve the robustness of the alert supplied by the system according to the invention, relative to the transmission errors. The encryption of the message comprises, for example, a simple cyclic redundancy in order to not increase its time of acquisition by the computer of the vehicle.

The invention relates also to a system for monitoring a tire of a motor vehicle, said system being situated in said tire, and comprising a means for measuring a temperature of said tire, and a means for measuring the pressure of said tire, said system further comprising a wireless emitter, said system being characterized in that it comprises:
calculation means suitable for calculating a variation, as an absolute value, of the ratio between a pressure measured by said pressure measurement means, and a temperature measured by said temperature measurement means, over a time period less than a predetermined duration,
means for comparing said variation to a predetermined threshold,
and means for sending an alert message to a computer of said vehicle if said variation is above a predetermined threshold over said time period.

According to an advantageous feature of the system for monitoring a tire of a motor vehicle according to the invention, said alert message comprises at least one information item chosen from:
the sign of said variation of said ratio between said measured pressure and said measured temperature,
the absolute value of said variation of said ratio between said measured pressure and said measured temperature,
the value of said time period,
and measurement values of said measured pressure and of said measured temperature over said time period.

According to another advantageous feature of the system for monitoring a tire of a motor vehicle according to the invention, said sending means comprise means for encrypting said alert message.

The system for monitoring a tire according to the invention presents advantages similar to those of the method for monitoring a tire according to the invention.

Other features and advantages will become apparent on reading a preferred embodiment described with reference to the figures in which:

FIG. 1 represents a vehicle provided with monitoring systems according to the invention,

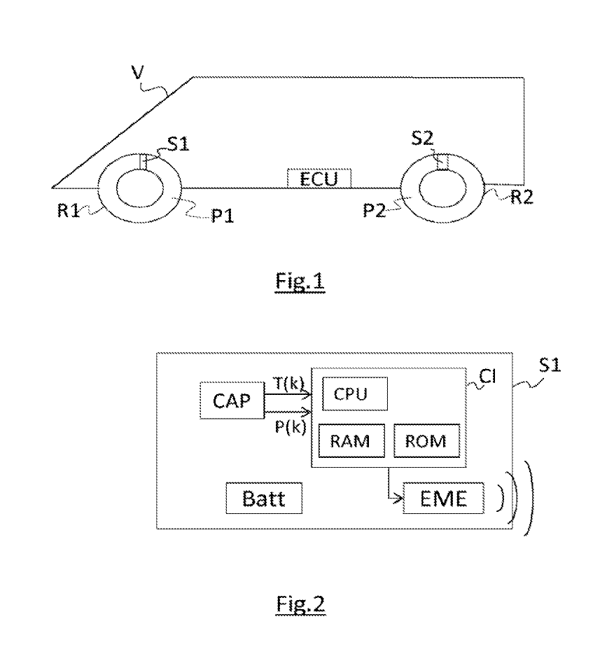

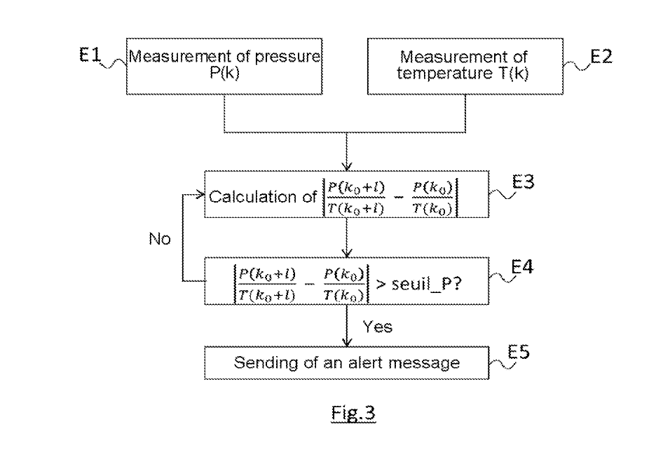

FIG. 2 represents a monitoring system according to the invention, in this preferred embodiment,

and FIG. 3 represents steps of a monitoring method according to the invention, in this preferred embodiment.

According to a preferred embodiment of the invention represented in FIG. 1, a vehicle V is equipped with a monitoring system according to the invention on each wheel of the vehicle V. Thus, the wheel R1 comprises a tire P1 comprising, in its valve, a monitoring system S1 according to the invention, and the wheel R2 comprises a tire P2 comprising, in its valve, another monitoring system S2 according to the invention.

These monitoring systems S1 and S2 can be likened to enhanced sensors, suitable for communicating wirelessly, for example by using the Wi-Fi technology defined by the IEEE 802.11 standard, or the Bluetooth standard, with a computer ECU of the vehicle V. The computer ECU of the vehicle is suitable for displaying, on a human-machine interface, alert information to a user of the vehicle.

Referring to FIG. 2, the monitoring system S1 is now described. It comprises a sensor CAP, itself comprising a means for measuring the pressure in the tire P1, and a means for measuring the temperature in the tire P1. As a variant, the system S1 comprises two sensors, each of these sensors being specifically for measuring a pressure or a temperature.

The sensor CAP measures a temperature T(k) for each measurement step k, and a pressure measurement P(k) for each measurement step k. These measurement steps are spaced apart by is (second) for example. The measurements of pressure P(k) and of temperature T(k) are sent at each new measurement step to a computer board CI. This computer board CI comprises a computer CPU, a random-access memory RAM and a read-only memory ROM.

The computer CPU is suitable for calculating a variation of mass of air of the tire and for comparing this variation as an absolute value to a predetermined threshold seuil_P. When this threshold is crossed, the computer board CI composes an alert message which is transmitted to a wireless emitter EME, which itself sends this alert message by Wi-Fi or Bluetooth to the computer of the vehicle V.

The computer board CI, the emitter EME and the sensor CAP are powered by a battery Batt.

Referring to FIG. 3, a monitoring method according to the invention is represented in the form of an algorithm comprising steps E1 to E5.

The method is implemented in the monitoring system S1 according to the invention. It is also implemented identically in the other three wheels of the vehicle V.

The step E1 is the measurement of the pressure of the tire P1. This measurement is a pressure relative to the reference atmospheric pressure, and is performed continually on each measurement step k.

The step E2 is the measurement of the temperature of the tire P1. This measurement is also performed continually on each measurement step k, in parallel with the step E1, and is representative of the temperature in the valve of the tire P1.

The step E3 is the calculation of the value:

$$\vert \frac{P ( {k}_{0} + 1 )}{T ( {k}_{0} + 1 )} - \frac{P ( {k}_{0} )}{T ( {k}_{0} )} \vert$$

in which:

P(k₀+1) is the pressure measured in the tire in the measurement step k₀+1, 1 being an integer variable,

T(k₀+1) is the pressure measured in the tire in the measurement step k₀+1,

P(k₀) is the pressure measured in the measurement step k₀,

T(k₀) is the temperature measured in the measurement step k₀.

Thus, from a starting measurement step k₀, the computer CPU measures, on each new measurement step, the variation of the absolute value of the ratio between the measured pressure and the measured temperature over a predetermined time period 1. 1 is a variable initialized at 1 and incrementing by 1 on each new measurement step up to an integer value less than or equal to a predetermined duration. This predetermined duration is set at ten measurement steps for example if the invention is used with another tire monitoring mode, or to thirty measurement steps if the invention is used as the only mode for monitoring the tires of the vehicle V. Beyond this predetermined duration, the computer CPU recommences calculating the variation of the absolute value of the ratio between the measured pressure and the measured temperature from a new starting measurement step k₀.

As a variant, the computer CPU measures the variation of the absolute value of the ratio between the measured pressure and the measured temperature, with 1 being fixed, the computer then taking a new starting measurement step k₀ every 1 measurement steps. In this variant 1 is for example equal to 10.

The step E4 is the comparison of the variation calculated as an absolute value in the step E3, with a predetermined threshold seuil_P, equal to 0.3 bar for example. This step E4 takes place for each new calculation performed in the step E3, therefore continually. If, in this step E4, the computer CPU determines that the variation calculated in the step E3 is below the threshold seuil_P, then the next step is a new step E3, otherwise the next step is the step E5.

The step E5 is the sending of an alert message to the computer ECU of the vehicle, by the emitter EME. This message is preferentially encrypted, for example by using a cyclic redundant code. This alert message comprises an indication of overshooting of the threshold seuil_P, representative of a loss of mass of air in the vehicle. This alert message preferentially comprises other information items, which are, notably:
the signed variation of the ratio between the measured pressure and said measured temperature, calculated in the preceding step E3. This datum makes it possible to distinguish a deflation from a reinflation.
The value of the integer number 1 used in the step E3 and corresponding to the time period used to calculate the variation of the ratio between the measured pressure and the measured temperature in the step E3. This value makes it possible to distinguish a rapid leak from a slow blow-out.
And measurement values of the measured pressure and of the measured temperature during this time period. These values make it possible to check the consistency of the information reported by the system according to the invention.

At the end of the step E5, the value of the variable 1 is updated to 1 and there is a return to the step E3, the computer taking the current measurement step k as new starting measurement step k₀. As a variant, this updating of the variable 1 and the restarting from the step E3 is performed only when requested by the computer ECU of the vehicle V, in order to avoid having the computer of the vehicle V continually receive alert messages in case of a rapid leak of the tire P1.

1-8. (canceled)

9. A method for monitoring a tire of a motor vehicle, implemented in a wheel including the tire, the method comprising:
measuring a temperature in the tire;
measuring a pressure in the tire;
calculating a variation, as an absolute value, of the ratio between the measured pressure and the measured temperature, over a period of time less than a predetermined duration;
comparing the calculated variation to a predetermined threshold; and
sending an alert message to a computer of the vehicle if the calculated variation is above the predetermined threshold over the time period.

10. The monitoring method as claimed in claim 9, wherein the alert message comprises the sign of the calculated variation.

11. The monitoring method as claimed in claim 9, wherein the alert message comprises the absolute value of the calculated variation, and the value of the time period.

12. The monitoring method as claimed in claim 9, wherein the alert message comprises measurement values of the measured pressure and of the measured temperature over the time period.

13. The monitoring method as claimed in claim 9, wherein the alert message is encrypted.

14. A system for monitoring a tire of a motor vehicle, the system being situated in the tire, and comprising:
means for measuring a temperature of the tire;
means for measuring a pressure of the tire;
calculation means configured to calculate a variation, as an absolute value, of the ratio between the pressure measured by the pressure measurement means, and the temperature measured by the temperature measurement means, over a time period less than a predetermined duration;
means for comparing the variation to a predetermined threshold; and
means for sending an alert message to a computer of the vehicle if the variation is above a predetermined threshold over the time period.

15. The system for monitoring a tire of a motor vehicle as claimed in claim 14, wherein the alert message comprises at least one information item chosen from:
the sign of variation of the ratio between the measured pressure and the measured temperature,
the absolute value of the variation of the ratio between the measured pressure and the measured temperature,
the value of the time period, or
measurement values of the measured pressure and of the measured temperature over the time period.

16. The system for monitoring a tire of a motor vehicle as claimed in claim 14, wherein the sending means comprises means for encrypting the alert message.
